(19) United States
(12) Patent Application Publication
(10) Pub. No.: US 2026/0132829 A1
(43) Pub. Date: May 14, 2026

(54) ELECTRIC BRAKING DEVICE

(71) Applicant: ADVICS CO., LTD., Kariya-shi, Aichi-ken (JP)

(72) Inventor: Yasutoshi KITAHARA, Kariya-shi, Aichi-ken (JP)

(73) Assignee: ADVICS CO., LTD., Kariya-shi, Aichi-ken (JP)

(21) Appl. No.: 19/118,668

(22) PCT Filed: Oct. 3, 2023
(86) PCT No.: PCT/JP2023/036055

§ 371 Date: Apr. 4, 2025

(30) Foreign Application Priority Data
Oct. 5, 2022 (JP) 2022-161269

(51) Int. Cl. F16D 65/18; B60T 13/74; B60T 17/22; F16D 66/00; F16D 121/24; F16D 125/40; F16D 125/48; F16D 131/00

(52) U.S. Cl. CPC F16D 65/18; B60T 13/746; B60T 17/22; F16D 66/00; F16D 2066/005; F16D 2121/24; F16D 2125/40; F16D 2125/48; F16D 2131/00

(57) ABSTRACT

An electric braking device is an electric braking device in which a rotary motion of a rotation part is converted into a linear motion of a linear motion part, the electric braking device including a sleeve, and an urging part configured to urge a load sensor toward a caliper to which the sleeve is fixed, where the sleeve includes a rotation lock part configured to guide the linear motion of the linear motion part while preventing rotation of the linear motion part accompanying rotation of the rotation part, and a support part configured to support the urging part

### TECHNICAL FIELD

The present disclosure relates to an electric braking device.

### BACKGROUND ART

Patent Literature 1 discloses a linear actuator including a shaft rotated forward and backward by a motor, a screw nut screw-attached to the shaft, and a piston tube fixed to the screw nut and configured to advance/retract accompanying rotation of the shaft. The piston tube and the screw nut are connected by a screw nut adapter, and the screw nut adapter prevents the rotation of the piston tube.

### CITATIONS LIST

### Patent Literature

Patent Literature 1: Japanese Patent Application Laid-Open No. 2014-029190

### SUMMARY

### Technical Problems

In the linear actuator disclosed in Patent Literature 1, the screw nut adapter has a function of preventing rotation of the piston tube, but there is room for improvement in suppressing manufacturing cost of the linear actuator. An object of one aspect of the present disclosure is to manufacture an electric braking device at low cost.

### Solutions to Problems

In order to solve the above problems, an electric braking device according to one aspect of the present disclosure is an electric braking device in which a rotary motion of an electric motor is transmitted to a rotation part of a linear motion conversion mechanism by a transmission mechanism, the rotary motion of the rotation part is converted into a linear motion of a linear motion part of the linear motion conversion mechanism in the linear motion conversion mechanism, and a friction member interlocked with the linear motion of the linear motion part is pressed against a rotating body rotating together with a wheel to generate a braking force on the wheel, the electric braking device including: a sleeve provided between the transmission mechanism and the friction member in a rotational axis direction of the rotation part and configured to cover the linear motion part, a caliper configured to accommodate the linear motion conversion mechanism and the sleeve and to which the sleeve is fixed, a load sensor provided between the linear motion part and the caliper in the rotational axis direction and configured to detect a reaction force of a pressing load of the friction member via the rotation part, and an urging part configured to have elasticity and to urge the load sensor toward the caliper, wherein the sleeve includes a rotation lock part configured to guide the linear motion of the linear motion part while preventing rotation of the linear motion part accompanying rotation of the rotation part, and a support part configured to support the urging part.

### Advantageous Effects

According to one aspect of the present disclosure, the electric braking device can be manufactured at low cost.

### BRIEF DESCRIPTION OF DRAWINGS

FIG. 1 is a schematic cross-sectional view illustrating an outline of an electric braking device according to a first embodiment.

FIG. 2 is an exploded view illustrating a state in which the respective members such as a linear motion conversion mechanism, a sleeve, and a load sensor included in the electric braking device illustrated in FIG. 1 are disassembled.

FIG. 3 is an exploded view illustrating a state in which the respective members such as the linear motion conversion mechanism, the sleeve, and the load sensor included in the electric braking device illustrated in FIG. 1 are disassembled.

FIG. 4 is a schematic cross-sectional view illustrating an outline of an electric braking device according to a second embodiment.

FIG. 5 is an exploded view illustrating a state in which the respective members such as a linear motion conversion mechanism, a sleeve, a piston, and a load sensor included in the electric braking device illustrated in FIG. 4 are disassembled.

FIG. 6 is an exploded view illustrating a state in which the respective members such as the linear motion conversion mechanism, the sleeve, the piston, and the load sensor included in the electric braking device illustrated in FIG. 4 are disassembled.

### DESCRIPTION OF EMBODIMENTS

### First Embodiment

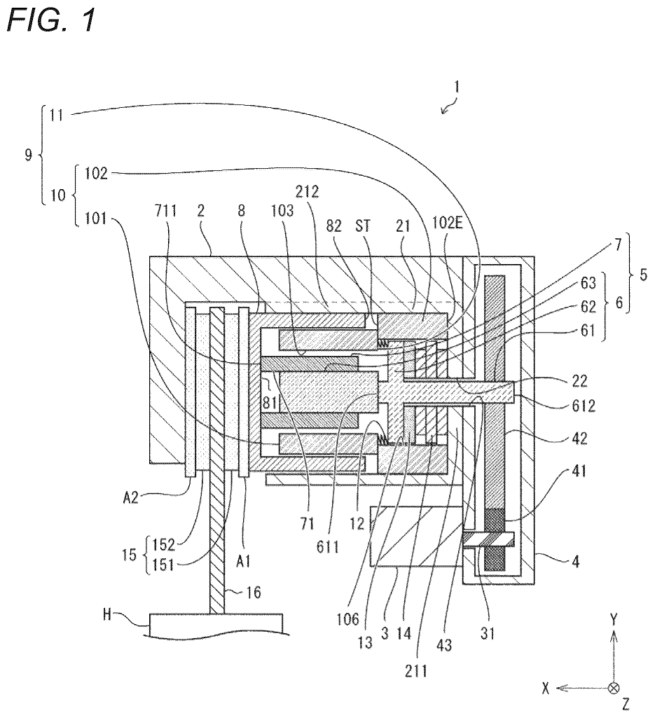

Hereinafter, a first embodiment of the present disclosure will be described in detail with reference to FIGS. 1 to 3. Note that in FIG. 1, a direction from a transmission mechanism 4 toward a rotating body 16 is defined as an X-axis direction, a direction from an electric motor 3 toward a rotation part 6 is defined as a Y-axis direction, and a direction orthogonal to both the X-axis direction and the Y-axis direction is defined as a Z-axis direction.

### Outline of Electric Braking Device 1

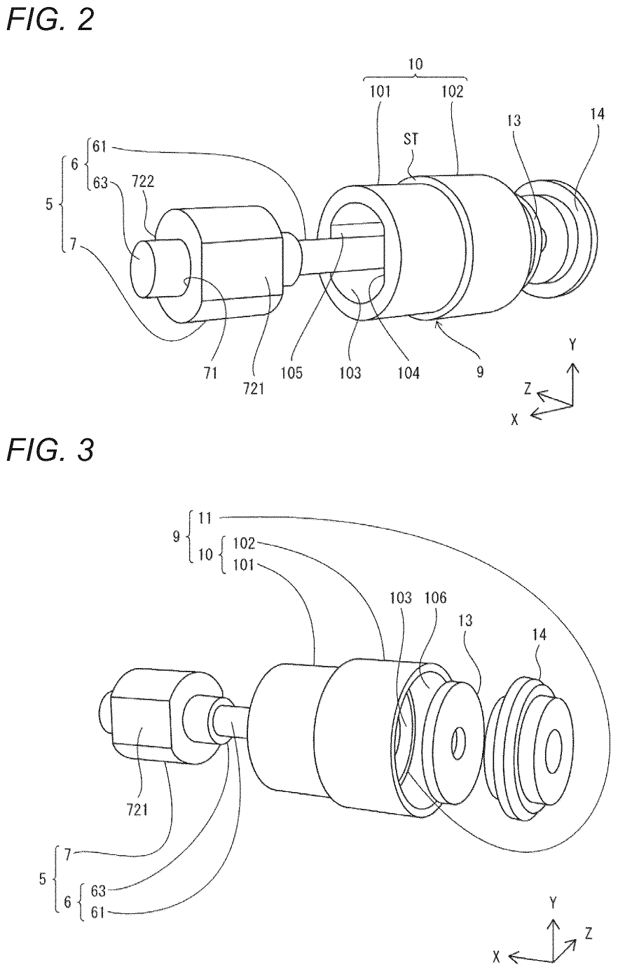

An outline of the electric braking device 1 will be described with reference to FIGS. 1 to 3. FIG. 1 is a schematic cross-sectional view illustrating an outline of the electric braking device 1 according to the first embodiment of the present disclosure. FIGS. 2 and 3 are exploded views illustrating a state in which the respective members such as a linear motion conversion mechanism 5, a sleeve 9, and a load sensor 14 included in the electric braking device 1 illustrated in FIG. 1 are disassembled. Note that in FIGS. 2 and 3, a flange portion 62 is omitted.

Examples of a device to which the electric braking device 1 is applied include an electromechanical brake called an electro mechanical brake (EMB) provided in a vehicle or the like. As illustrated in FIG. 1, the electric braking device 1 includes a caliper 2 (corresponding to a housing), the sleeve 9, an urging part 12, and the load sensor 14. Furthermore, the electric braking device 1 may further include the electric motor 3, the transmission mechanism 4, the linear motion conversion mechanism 5, a piston 8, a thrust bearing 13, a friction member 15, and an electronic control unit (ECU) (not illustrated).

### Configuration of Electric Motor 3

The electric motor 3 is a power source of the electric braking device 1. The electric motor 3 is electrically connected to the ECU and is driven based on the control of the ECU. The electric motor 3 is disposed outside the caliper 2 so as to be adjacent to the caliper 2. The electric motor 3 has a rotating shaft 31 provided with a gear 41 that meshes with a gear 42. When the electric motor 3 is driven, the rotating shaft 31 rotates, and the rotary motion is transmitted from the gear 41 provided on the rotating shaft 31 to the gear 42.

### Configuration of Transmission Mechanism 4

The transmission mechanism 4 is a mechanism configured to transmit the rotary motion of the electric motor 3 to the rotation part 6 of the linear motion conversion mechanism 5. The transmission mechanism 4 is disposed outside the caliper 2. The transmission mechanism 4 includes gears 41 and 42 to which the rotary motion from the electric motor 3 is transmitted. The transmission mechanism 4 transmits the rotary motion of the electric motor 3 to the rotation part 6 of the linear motion conversion mechanism 5 by the gears 41 and 42. The transmission mechanism 4 has two gears 41 and 42, but may have three or more gears. Furthermore, the transmission mechanism 4 may be a speed reduction mechanism that speed-reduces the rotary motion transmitted from the electric motor 3.

### Configuration of Linear Motion Conversion Mechanism 5

The linear motion conversion mechanism 5 is a mechanism configured to convert the rotary motion of the electric motor 3 transmitted from the transmission mechanism 4 into a linear motion. The linear motion conversion mechanism 5 includes a rotation part 6 to which the rotary motion of the electric motor 3 is transmitted by the transmission mechanism 4, and a linear motion part 7 that linearly moves by converting the rotary motion of the rotation part 6 into a linear motion.

The rotation part 6 includes a rotating shaft portion 61, a flange portion 62, and a screw portion 63. The rotating shaft portion 61 has the X-axis direction as the rotational axis. That is, the X-axis direction is the rotational axis direction of the rotation part 6. The flange portion 62 is provided between an end portion 611 of the rotating shaft portion 61 on the friction member 15 side and an end portion 612 of the rotating shaft portion 61 on the transmission mechanism 4 side.

The flange portion 62 extends from the rotating shaft portion 61 toward the outward direction of the rotating shaft portion 61 in the radial direction of the rotating shaft portion 61. A gear 42 is provided at the end portion 612 of the rotating shaft portion 61 and meshes with the gear 41. The screw portion 63 is provided at the end portion 611 of the rotating shaft portion 61. A male screw is formed in the screw portion 63.

A through-hole 71 into which the screw portion 63 of the rotation part 6 is inserted is formed in the linear motion part 7. As illustrated in FIGS. 2 and 3, the shape of the linear motion part 7 is a substantially cylindrical shape. In the present embodiment, the substantially cylindrical shape includes, for example, a shape in which a flat surface is formed on a part of the outer peripheral surface or the inner peripheral surface, and a shape including two cylindrical portions arranged side by side in the X-axis direction and connected to each other. In the case of the linear motion part 7, the shape of the linear motion part 7 is a shape in which a flat surface is formed on a part of the outer peripheral surface. Details will be described later.

A female screw into which a male screw of the screw portion 63 is screw-fitted is formed on an inner peripheral surface of the through-hole 71. When the male screw of the screw portion 63 is screw-fitted into the female screw of the linear motion part 7, the rotary motion of the rotation part 6 is converted into the linear motion of the linear motion part 7. The screw portion 63 and the linear motion part 7 may constitute, for example, a ball screw.

More specifically, when the rotary motion of the electric motor 3 in the first rotating direction is transmitted to the rotation part 6, the linear motion part 7 linearly moves in the positive direction of the X-axis, and when the rotary motion of the electric motor 3 in the second rotating direction opposite to the first rotating direction is transmitted to the rotation part 6, the linear motion part linearly moves in the negative direction of the X-axis. A distal end 711 of the linear motion part 7 on the friction member 15 side is fixed to the piston 8. The linear motion part 7 is, for example, a nut member. Note that the linear motion part 7 and the piston 8 may be integrated with each other.

### Configuration of Piston 8

The piston 8 is provided between the linear motion part 7 and the friction member 15 in the X-axis direction, and covers the outer peripheral surface of a first cylindrical portion 101. The shape of the piston 8 is a cylindrical shape. The outer diameter of the piston 8 is greater than or equal to the inner diameter of a second cylindrical portion 102, and the inner diameter of the piston 8 is smaller than or equal to the outer diameter of the second cylindrical portion 102.

When the linear motion part 7 linearly moves in the positive direction of the X-axis, the piston 8 linearly moves in the positive direction of the X-axis and is pressed toward the friction member 15 by the linear motion part 7. Furthermore, when the linear motion part 7 linearly moves in the negative direction of the X-axis, the piston 8 linearly moves in the negative direction of the X-axis. In this manner, the piston 8 is interlocked with the linear motion of the linear motion part 7. An open hole 81 is formed in the piston 8, and the screw portion 63, the linear motion part 7, and the first cylindrical portion 101 of the sleeve 9 are inserted into the open hole 81.

### Configuration of Friction Member 15

The friction member 15 is a member that presses the rotating body 16 that rotates together with the wheel H included in the vehicle to generate a braking force on the wheel H. As the friction member 15, there are a first friction member 151 located on the linear motion conversion mechanism 5 side with respect to the rotating body 16 and a second friction member 152 located on the opposite side to the first friction member 151 with the rotating body 16 interposed therebetween.

The first friction member 151 is attached to the piston 8 by way of an attachment plate A1. The second friction member 152 is attached to the caliper 2 by way of an attachment plate A2. The first friction member 151 is interlocked with the linear motion of the piston 8. That is, the first friction member 151 is a member that presses the rotating body 16 to generate the braking force on the wheel H in conjunction with the linear motion of the linear motion part 7.

When the first friction member 151 linearly moves in the positive direction of the X-axis, which is the direction toward the rotating body 16, the rotating body 16 is pressed so as to sandwich the rotating body 16 between the first friction member 151 and the second friction member 152. When the rotating body 16 is pressed by the first friction member 151 and the second friction member 152, frictional force is generated between each of the first friction member 151 and the second friction member 152 and the rotating body 16. This frictional force acts on the wheel H as a force in a direction opposite to the rotating direction of the rotating body 16. As a result, a braking force on the wheel H is generated.

When the pressing load by the friction member 15 is strong, the frictional force with respect to the rotating body 16 becomes strong, and the braking force with respect to the wheel H becomes strong. When the pressing load by the friction member 15 is weak, the frictional force with respect to the rotating body 16 becomes weak, and the braking force with respect to the wheel H becomes weak. On the other hand, when the first friction member 151 moves in the negative direction of the X-axis, which is the direction away from the rotating body 16, the pressing of the rotating body 16 by the first friction member 151 and the second friction member 152 is released. Since no frictional force is generated with respect to the rotating body 16, the braking force with respect to the wheel H disappears.

### Configuration of Caliper 2

The caliper 2 is provided so as to cross a peripheral edge portion of the rotating body 16 from both sides of the rotating body 16. The caliper 2 accommodates the linear motion conversion mechanism 5, the piston 8, the sleeve 9, the urging part 12, the thrust bearing 13, the load sensor 14, and the friction member 15. The caliper 2 includes a cylinder portion 21, and the cylinder portion 21 is opened on the X-axis positive direction side.

The linear motion conversion mechanism 5, the piston 8, the sleeve 9, the urging part 12, the thrust bearing 13, and the load sensor 14 are disposed in an opening formed in the cylinder portion 21. The rotating shaft portion 61 is inserted into a through-hole 22 formed in the cylinder portion 21 and a through-hole 43 formed in the outer wall of the transmission mechanism 4.

### Configuration of Sleeve 9 and Urging Part 12

The sleeve 9 is provided between the transmission mechanism 4 and the friction member 15 in the X-axis direction, and covers the linear motion part 7. The sleeve 9 has a rotation lock part 10 and a support part 11, and is fixed to the cylinder portion 21 of the caliper 2. The sleeve 9 has a shape in which a cylindrical first cylindrical portion 101 and a cylindrical second cylindrical portion 102 are arranged side by side in the X-axis direction. The rotation lock part 10 guides the linear motion of the linear motion part 7 while preventing the rotation of the linear motion part 7 when the rotation part 6 rotates. In other words, the rotation lock part 10 guides the linear motion of the linear motion part 7 while preventing the rotation of the linear motion part 7 accompanying the rotation of the rotation part 6. Details will be described below.

As illustrated in FIGS. 2 and 3, the shape of the rotation lock part 10 is a substantially cylindrical shape. More specifically, the rotation lock part 10 includes the first cylindrical portion 101 and the second cylindrical portion 102 that are disposed side by side in the X-axis direction and connected to each other.

A through-hole 103 into which the linear motion part 7 is fitted is formed in the first cylindrical portion 101. That is, the linear motion part 7 is fitted to the inner peripheral surface of the first cylindrical portion 101.

Each of first flat surfaces 721 and 722 that are flat surfaces formed on a part of the outer peripheral surface of the linear motion part 7 abuts on second flat surfaces 104 and 105 that are flat surfaces formed on a part of the inner peripheral surface of the through-hole 103 of the first cylindrical portion 101, respectively.

The linear motion part 7 linearly moves in the X-axis direction while each of the first flat surfaces 721 and 722 abuts on the second flat surfaces 104 and 105, respectively. A through hole 106 formed in the second cylindrical portion 102 communicates with the through-hole 103. The inner diameter of the second cylindrical portion 102 is larger than the inner diameter of the first cylindrical portion 101, and the outer diameter of the second cylindrical portion 102 is larger than the outer diameter of the first cylindrical portion 101. As illustrated in FIG. 1, the screw portion 63 is disposed inside the through-hole 103, and the rotating shaft portion 61, the flange portion 62, the thrust bearing 13, and the load sensor 14 are disposed inside the through-hole 106.

As described above, the linear motion part 7 is fitted into the through-hole 103 formed in the rotation lock part 10 having a substantially cylindrical shape, and the first flat surfaces 721 and 722 formed on a part of the outer peripheral surface of the linear motion part 7 abut on the second flat surfaces 104 and 105 formed on a part of the inner peripheral surface of the rotation lock part 10. Accordingly, rotation of the linear motion part 7 accompanying the rotation of the rotation part 6 can be prevented by the rotation lock part 10.

Furthermore, the processing of forming the first flat surfaces 721 and 722 on the linear motion part 7 and forming the second flat surfaces 104 and 105 on the rotation lock part 10 is simpler than the processing of forming a convex portion on the linear motion part 7 and forming a groove into which the convex portion is fitted in the member to which the linear motion part 7 is to be fitted. Therefore, the electric braking device 1 can be manufactured at low cost.

Furthermore, since the rotation of the linear motion part 7 can be prevented by the rotation lock part 10, the processing of forming a convex portion in the linear motion part 7 and forming a groove into which the convex portion is fitted in the member into which the linear motion part 7 is to be fitted becomes unnecessary. Moreover, the processing of forming a convex portion on the piston 8 and forming a groove into which the convex portion is fitted in the cylinder portion 21 is also unnecessary. In addition, the processing of forming a male screw on the piston 8 and forming a female screw, which has a diameter larger than the diameter of the piston 8 and to which the male screw is screw-fitted, on the cylinder portion 21 in order to fix the load sensor 14 is unnecessary. Since these processing become unnecessary, the electric braking device 1 can be manufactured at low cost.

Note that the second flat surface 104 may be formed on the inner peripheral surface of the through-hole 103, and the second flat surface 105 may not be formed. That is, one second flat surface 104 may be formed on the inner peripheral surface of the through-hole 103. In this case, the first flat surface 721 is formed on the outer peripheral surface of the linear motion part 7, and the first flat surface 722 is not formed. Furthermore, the first cylindrical portion 101 and the second cylindrical portion 102 may be integrated with each other.

The support part 11 supports the urging part 12. The urging part 12 has elasticity and is provided on the support part 11. The urging part 12 is, for example, a coil spring. Note that the urging part 12 is not limited to the coil spring, and may be, for example, a disc spring. In a case where the urging part 12 is a coil spring, a plurality of urging parts 12 are provided on the support part 11. In a case where the urging part 12 is a disc spring, at least one urging part 12 is provided on the support part 11. The urging part 12 urges the flange portion 62 toward the cylinder portion 21 of the caliper 2, thereby urging the load sensor 14 toward the cylinder portion 21.

The support part 11 is a first step difference formed on the inner peripheral surface of the rotation lock part 10. More specifically, as illustrated in FIG. 3, the support part 11 is the first step difference formed between the inner peripheral surface of the first cylindrical portion 101 and the inner peripheral surface of the second cylindrical portion 102 as the inner diameter of the second cylindrical portion 102 is larger than the inner diameter of the first cylindrical portion 101. That is, the support part 11 is the first step difference formed between the through-hole 103 and the through-hole 106. The support part 11 is formed on the transmission mechanism 4 side than the first cylindrical portion 101.

According to the above configuration, the urging part 12 can be supported by the first step difference formed on the inner peripheral surface of the rotation lock part 10, and the load sensor 14 can be urged toward the caliper 2. The support part 11 for supporting the urging part 12 can be easily formed on the inner peripheral surface of the rotation lock part 10 by connecting the first cylindrical portion 101 and the second cylindrical portion 102.

Furthermore, as illustrated in FIGS. 1 and 2, a second step difference ST is formed on the outer peripheral surface of the rotation lock part 10. The second step difference ST formed on the outer peripheral surface of the rotation lock part 10 regulates the movement of the piston 8 in the direction toward the transmission mechanism 4 in the X-axis direction. More specifically, when the piston 8 linearly moves in the negative direction of the X-axis, the end portion 82 of the piston 8 on the transmission mechanism 4 side abuts on the second step difference ST. As a result, the movement of the piston 8 in the direction toward the transmission mechanism 4 is regulated by the second step difference ST.

The second step difference ST formed on the outer peripheral surface of the rotation lock part 10 can have a function of regulating the movement of the piston 8 in the direction toward the transmission mechanism 4 in the X-axis direction with respect to the sleeve 9. When the shape of the sleeve 9 is a shape in which the first cylindrical portion 101 and the second cylindrical portion 102 having different diameters are arranged side by side, the first step difference formed on the inner peripheral surface of the sleeve 9 and the second step difference ST formed on the outer peripheral surface of the sleeve 9 can have different functions.

Therefore, the sleeve 9 can have three functions of a function of guiding the linear motion of the linear motion part 7, a function of urging the load sensor 14 toward the caliper 2, and a function of regulating the movement of the piston 8 in the direction toward the transmission mechanism 4 without complicating the shape of the sleeve 9. Therefore, the number of components of the electric braking device 1 can be reduced, and the electric braking device 1 can be manufactured at low cost.

The second step difference ST formed on the outer peripheral surface of the rotation lock part 10 is a step difference formed between the outer peripheral surface of the first cylindrical portion 101 and the outer peripheral surface of the second cylindrical portion 102 as the outer diameter of the first cylindrical portion 101 is smaller than the outer diameter of the second cylindrical portion 102. By connecting the first cylindrical portion 101 and the second cylindrical portion 102, the second step difference ST for regulating the movement of the piston 8 toward the transmission mechanism 4 side can be easily formed on the outer peripheral surface of the rotation lock part 10. The length of the first cylindrical portion 101 along the X-axis direction is a length of an extent the piston 8 does not come out of the first cylindrical portion 101 even when the friction member 15 is worn.

### Fixation of Second Cylindrical Portion 102 to Cylinder Portion 21

The second cylindrical portion 102 is fixed to the cylinder portion 21 of the caliper 2. More specifically, a screw passing through a through-hole formed in the bottom portion 211 of the cylinder portion 21 is fastened to a screw hole formed in the end portion 102E of the second cylindrical portion 102 on the transmission mechanism 4 side, whereby the second cylindrical portion 102 is fixed to the cylinder portion 21. Note that the second cylindrical portion 102 may be fixed to the cylinder portion 21 by fastening a screw passing through a through-hole formed in the end portion 102E to a screw hole formed in the bottom portion 211.

As a modified example, the second cylindrical portion 102 may be fixed to the cylinder portion 21 by fastening a screw passing through a through-hole formed in the side portion 212 of the cylinder portion 21 to a screw hole formed in the outer peripheral surface of the second cylindrical portion 102. Note that the second cylindrical portion 102 may be fixed to the cylinder portion 21 by fastening a screw passing through a through-hole formed in the outer peripheral surface of the second cylindrical portion 102 to a screw hole formed in the side portion 212.

As still another modified example, the second cylindrical portion 102 may be fixed to the cylinder portion 21 by screw-fitting a male screw formed on the outer peripheral surface of the second cylindrical portion 102 to a female screw formed on the inner peripheral surface of the cylinder portion 21.

### Configurations of Thrust Bearing 13 and Load Sensor 14

The thrust bearing 13 is disposed between the flange portion 62 and the load sensor 14 in the X-axis direction. The load sensor 14 is provided between the linear motion part 7 and the caliper 2 in the X-axis direction, and is configured to detect a reaction force of a pressing load of the friction member 15 through the rotation part 6. More specifically, the load sensor 14 is provided between the thrust bearing 13 and the cylinder portion 21 in the X-axis direction. As illustrated in FIGS. 2 and 3, the load sensor 14 is, for example, an annular load sensor. Note that the load sensor 14 is not limited to an annular load sensor, and may be a button type load sensor.

### Configuration of ECU

The ECU is a control unit configured to control the electric braking device 1. The ECU includes a processor such as a central processing unit (CPU) and a computer having a memory such as a RAM or a ROM. The ECU also includes a drive circuit configured to drive the electric motor 3 and an input/output interface configured to acquire data of a reaction force of a pressing load detected by the load sensor 14.

The ECU is disposed outside the caliper 2. The ECU is electrically connected to the electric motor 3 and the load sensor 14. The ECU controls the number of rotations per unit time in the electric motor 3 based on the data of the reaction force of the pressing load detected by the load sensor 14 to control the braking force on the wheel H.

As described above, the sleeve 9 fixed to the caliper 2 has two functions of a function of guiding the linear motion of the linear motion part 7 while preventing the rotation of the linear motion part 7 accompanying the rotation of the rotation part 6 and a function of urging the load sensor 14 toward the caliper 2. As a result, as compared with a case where the caliper 2 has the above two functions, processing of the caliper 2 is simplified, and the electric braking device 1 can be manufactured at low cost.

### Second Embodiment

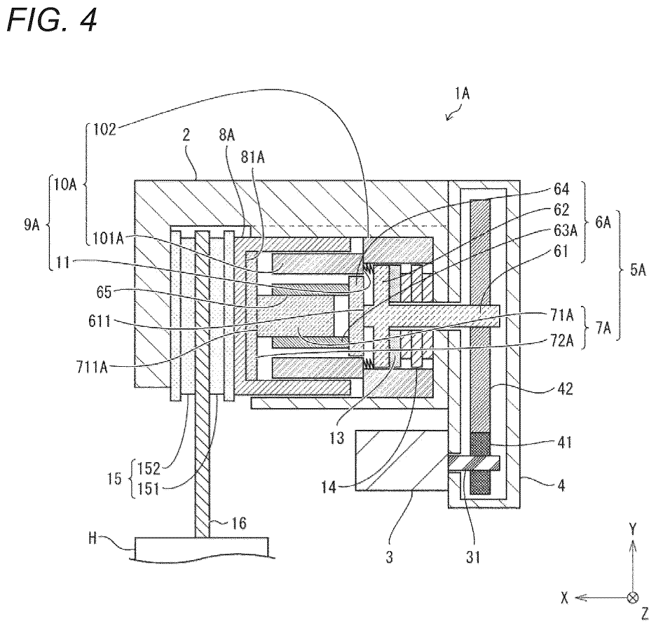

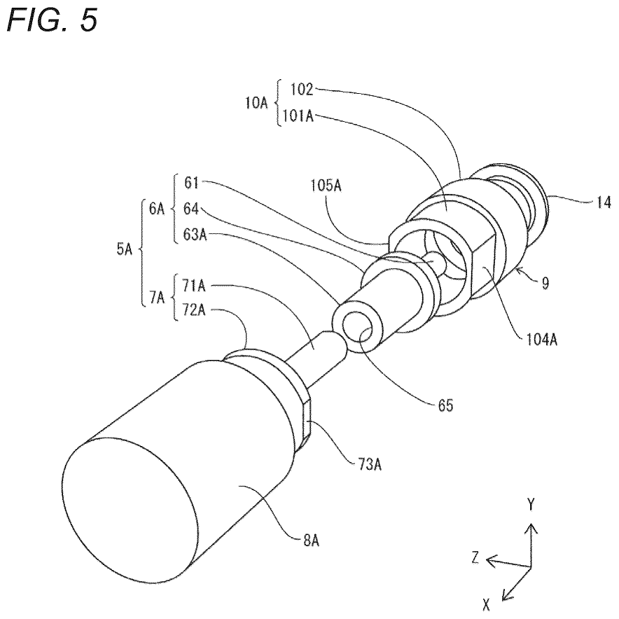

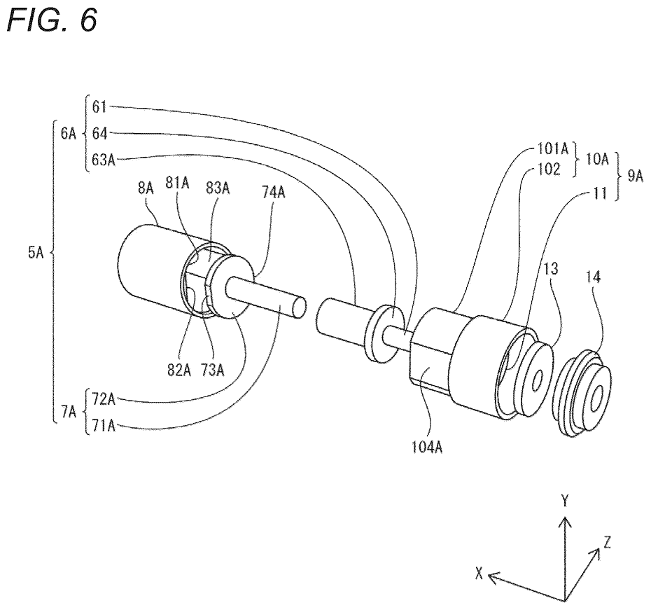

A second embodiment of the present disclosure will be described below. For the sake of convenience of description, members having the same functions as the members described in the first embodiment are denoted by the same reference numerals, and the description thereof will not be repeated. FIG. 4 is a schematic cross-sectional view illustrating an outline of an electric braking device 1A according to the second embodiment of the present disclosure. FIGS. 5 and 6 are exploded views illustrating a state in which the respective members such as a linear motion conversion mechanism 5A, a sleeve 9A, a piston 8A, and a load sensor 14 included in the electric braking device 1A illustrated in FIG. 4 are disassembled. Note that in FIGS. 5 and 6, a flange portion 62 is omitted.

As illustrated in FIG. 4, the electric braking device 1A is different from the electric braking device 1 in that the linear motion conversion mechanism 5 is changed to the linear motion conversion mechanism 5A, the piston 8 is changed to the piston 8A, and the sleeve 9 is changed to the sleeve 9A.

### Configuration of Linear Motion Conversion Mechanism 5A

The linear motion conversion mechanism 5A is different from the linear motion conversion mechanism 5 in that the rotation part 6 is changed to a rotation part 6A and the linear motion part 7 is changed to a pressing part 7A. The rotation part 6A is different from the rotation part 6 in that the rotation part 6A includes a screw portion 63A instead of the screw portion 63 and further includes a connecting portion 64. The connecting portion 64 is provided at the end portion 611 of the rotating shaft portion 61. The connecting portion 64 connects the rotating shaft portion 61 and the screw portion 63A. An open hole 65 is formed in the screw portion 63A, and a female screw is formed on an inner peripheral surface of the open hole 65. The screw portion 63A is, for example, a nut member.

The pressing part 7A presses the bottom surface of an open hole 81A formed in the piston 8A toward the friction member 15. The pressing part 7A includes a screw portion 71A and a pressing plate 72A. A male screw to be screw-fitted into the female screw of the open hole 65 is formed in the screw portion 71A. When the male screw of the screw portion 71A is screw-fitted into the female screw of the open hole 65, the rotary motion of the rotation part 6A is converted into the linear motion of the pressing part 7A.

An end portion 711A of the screw portion 71A on the friction member 15 side is fixed to the pressing plate 72A. The pressing plate 72A extends along the YZ plane. The shape of the pressing plate 72A is a substantially circular plate shape. When the pressing part 7A linearly moves in the positive direction of the X-axis, the pressing plate 72A abuts on the bottom surface of open hole 81A. As a result, the piston 8A linearly moves in the positive direction of the X-axis and is pressed toward the friction member 15 by the pressing part 7A.

### Configuration of Piston 8A

The piston 8A is different from the piston 8 in that the open hole 81 is changed to the open hole 81A. As illustrated in FIGS. 5 and 6, the shape of the piston 8A is a substantially cylindrical shape. Fourth flat surfaces 82A and 83A, which are flat surfaces formed on a part of the inner peripheral surface of the open hole 81A, abut on fifth flat surfaces 73A and 74A, which are flat surfaces formed on a part of the outer peripheral surface of the pressing plate 72A, respectively. The linear motion part according to the present embodiment is a portion having the piston 8A and the pressing part 7A.

### Sleeve 9A

The sleeve 9A is different from the sleeve 9 in that the rotation lock part 10 is changed to a rotation lock part 10A. The rotation lock part 10A is different from the rotation lock part 10 in that the first cylindrical portion 101 is changed to a first cylindrical portion 101A. The shape of the rotation lock part 10A is a substantially cylindrical shape. The rotation lock part 10A is fitted into the open hole 81A formed in the piston 8A. More specifically, the first cylindrical portion 101A is fitted into the open hole 81A.

When the first cylindrical portion 101A is fitted into the open hole 81A, the third flat surfaces 104A and 105A, which are flat surfaces formed on a part of the outer peripheral surface of the first cylindrical portion 101A, abut on the fourth flat surfaces 82A and 83A, which are flat surfaces formed on a part of the inner peripheral surface of the piston 8A, respectively. The pressing part 7A linearly moves in the X-axis direction while the third flat surfaces 104A and 105A abut on the fourth flat surfaces 82A and 83A, respectively, and the fifth flat surfaces 73A and 74A abut on the fourth flat surfaces 82A and 83A, respectively.

According to the above configuration, the piston 8A does not rotate with respect to the sleeve 9A fixed to the caliper 2, and the pressing part 7A does not rotate with respect to the piston 8A. Therefore, the third flat surfaces 104A and 105A abut on the fourth flat surfaces 82A and 83A, respectively, so that the rotation of the piston 8A and the pressing part 7A accompanying the rotation of the rotation part 6A can be prevented.

Furthermore, the processing of forming the third flat surfaces 104A and 105A in the rotation lock part 10A and forming the fourth flat surfaces 82A and 83A in the piston 8A is simpler than the processing of forming a groove in the piston 8A and forming a convex portion to be fitted to the groove in a member to be fitted to the piston 8A. Therefore, the electric braking device 1A can be manufactured at low cost.

Furthermore, the rotation of the linear motion part accompanying the rotation of the rotation part 6A can be prevented by the rotation lock part 10A using the linear motion part having the substantially cylindrical piston 8A and the pressing part 7A that presses the bottom surface of the open hole 81A formed in the piston 8A toward the friction member 15.

### Modified Example

In the electric braking device 1 illustrated in FIG. 1, when the first cylindrical portion 101 is fitted into the open hole 81, the two third flat surfaces formed on a part of the outer peripheral surface of the first cylindrical portion 101 may abut on the two fourth flat surfaces formed on a part of the inner peripheral surface of the piston 8. In this case, the linear motion part 7 linearly moves in the X-axis direction while the two third flat surfaces are in abutment with the two fourth flat surfaces.

Furthermore, in the modified example, the first flat surfaces 721 and 722 may not be formed on the outer peripheral surface of the linear motion part 7, and the second flat surface 104 and 105 may not be formed on the inner peripheral surface of the through-hole 103 of the first cylindrical portion 101. In this case, the shapes of the linear motion part 7 and the first cylindrical portion 101 have a cylindrical shape. As described above, a flat surface is formed on a part of at least one of the inner peripheral surface and the outer peripheral surface of the first cylindrical portion 101.

The present disclosure is not limited to the above-described embodiments, and various modifications can be made within the scope indicated in the Claims, and embodiments obtained by appropriately combining technical means disclosed in different embodiments are also included in the technical scope of the present disclosure.

1. An electric braking device in which a rotary motion of an electric motor is transmitted to a rotation part of a linear motion conversion mechanism by a transmission mechanism, the rotary motion of the rotation part is converted into a linear motion of a linear motion part of the linear motion conversion mechanism in the linear motion conversion mechanism, and a friction member interlocked with the linear motion of the linear motion part is pressed against a rotating body rotating together with a wheel to generate a braking force on the wheel, the electric braking device comprising:
a sleeve provided between the transmission mechanism and the friction member in a rotational axis direction of the rotation part and configured to cover the linear motion part;
a housing configured to accommodate the linear motion conversion mechanism and the sleeve and to which the sleeve is fixed;
a load sensor provided between the linear motion part and the housing in the rotational axis direction and configured to detect a reaction force of a pressing load of the friction member via the rotation part; and
an urging part configured to have elasticity and to urge the load sensor toward the housing; wherein
the sleeve includes a rotation lock part configured to guide the linear motion of the linear motion part while preventing rotation of the linear motion part accompanying rotation of the rotation part, and a support part configured to support the urging part.

2. The electric braking device according to claim 1, wherein
a shape of the rotation lock part is a substantially cylindrical shape, the linear motion part is fitted to an inner peripheral surface of the rotation lock part, and
the rotation of the linear motion part is prevented by abutment between a first flat surface that is a flat surface formed on a part of an outer peripheral surface of the linear motion part and a second flat surface that is a flat surface formed on a part of an inner peripheral surface of the rotation lock part.

3. The electric braking device according to claim 1, wherein
shapes of the rotation lock part and the linear motion part are substantially cylindrical shape, the rotation lock part is fitted to an open hole formed in the linear motion part, and
the rotation of the linear motion part is prevented by abutment between a third flat surface that is a flat surface formed on a part of an outer peripheral surface of the rotation lock part and a fourth flat surface that is a flat surface formed on a part of an inner peripheral surface of the linear motion part.

4. The electric braking device according to an claim 3, wherein
the sleeve has a shape in which a first cylindrical portion having a cylindrical shape and a second cylindrical portion having a cylindrical shape and having an inner diameter and an outer diameter larger than those of the first cylindrical portion are arranged in the rotational axis direction, a piston having a cylindrical shape that interlocks with the linear motion part, the piston being provided between the linear motion part and the friction member in the rotational axis direction, covering an outer peripheral surface of the first cylindrical portion, having an outer diameter of greater than or equal to an inner diameter of the second cylindrical portion, and having an inner diameter of less than or equal to an outer diameter of the second cylindrical portion,
the support part is a first step difference formed between an inner peripheral surface of the first cylindrical portion and an inner peripheral surface of the second cylindrical portion by setting the inner diameter of the second cylindrical portion to be larger than the inner diameter of the first cylindrical portion, and
movement of the piston in a direction toward the transmission mechanism is regulated by a second step difference formed between the outer peripheral surface of the first cylindrical portion and the outer peripheral surface of the second cylindrical portion by setting the outer diameter of the first cylindrical portion to be smaller than the outer diameter of the second cylindrical portion.

5. The electric braking device according to claim 2, wherein
the sleeve has a shape in which a first cylindrical portion having a cylindrical shape and a second cylindrical portion having a cylindrical shape and having an inner diameter and an outer diameter larger than those of the first cylindrical portion are arranged in the rotational axis direction, a piston having a cylindrical shape that interlocks with the linear motion part, the piston being provided between the linear motion part and the friction member in the rotational axis direction, covering an outer peripheral surface of the first cylindrical portion, having an outer diameter of greater than or equal to an inner diameter of the second cylindrical portion, and having an inner diameter of less than or equal to an outer diameter of the second cylindrical portion,
the support part is a first step difference formed between an inner peripheral surface of the first cylindrical portion and an inner peripheral surface of the second cylindrical portion by setting the inner diameter of the second cylindrical portion to be larger than the inner diameter of the first cylindrical portion, and
movement of the piston in a direction toward the transmission mechanism is regulated by a second step difference formed between the outer peripheral surface of the first cylindrical portion and the outer peripheral surface of the second cylindrical portion by setting the outer diameter of the first cylindrical portion to be smaller than the outer diameter of the second cylindrical portion.

6. The electric braking device according to claim 1, wherein
the sleeve has a shape in which a first cylindrical portion having a cylindrical shape and a second cylindrical portion having a cylindrical shape and having an inner diameter and an outer diameter larger than those of the first cylindrical portion are arranged in the rotational axis direction, a piston having a cylindrical shape that interlocks with the linear motion part, the piston being provided between the linear motion part and the friction member in the rotational axis direction, covering an outer peripheral surface of the first cylindrical portion, having an outer diameter of greater than or equal to an inner diameter of the second cylindrical portion, and having an inner diameter of less than or equal to an outer diameter of the second cylindrical portion,
the support part is a first step difference formed between an inner peripheral surface of the first cylindrical portion and an inner peripheral surface of the second cylindrical portion by setting the inner diameter of the second cylindrical portion to be larger than the inner diameter of the first cylindrical portion, and
movement of the piston in a direction toward the transmission mechanism is regulated by a second step difference formed between the outer peripheral surface of the first cylindrical portion and the outer peripheral surface of the second cylindrical portion by setting the outer diameter of the first cylindrical portion to be smaller than the outer diameter of the second cylindrical portion.
